(19) United States
(12) Patent Application Publication
(10) Pub. No.: US 2001/0021425 A1
(43) Pub. Date: Sep. 13, 2001

(54) Three-layer furniture bag

(76) Inventor: Howard Lynn Lincecum, Monroe, LA (US)

Correspondence Address: Lance A. Foster, ROY, KIESEL & TUCKER, P.O. Box 15928, 2355 Drusilla Lane, Baton Rouge, LA, 70895-5928, US

(21) Appl. No.: 09/775,451

(22) Filed: Feb. 1, 2001

Related U.S. Application Data
(60) Provisional application No. 60/185,298, filed on Feb. 28, 2000.
(60) Provisional application No. 60/186,887, filed on Mar. 3, 2000.

(51) Int. Cl. B32B 1/02

(52) U.S. Cl. 428/35.7; 150/158

(57) ABSTRACT

An improved furniture bag formed of a dual surface material. The dual surface material has an inside surface with a first coefficient of friction and an outside surface with a second and higher coefficient of friction. The lower coefficient of friction inside surface allows the bag to more easily side onto items of furniture. The higher coefficient of friction outside surface allows for easier handling of the bag and easier application of adhesives on tape and labels.

This utility patent application claims benefit of provisional patent application No. 60/185,298, filed on Feb. 28, 2000, and provisional patent application No. 60/186,887, filed on Mar. 3, 2000.

### I. BACKGROUND OF THE INVENTION

The present invention relates to bags, generally formed of some type of plastic material, which are used to protect items during shipment. More specifically, the present invention relates to bags which are particularly suited for covering items of furniture (e.g. sofas,, loveseats, mattresses, etc.). While these types of bags are typically constructed out of a polymer material such as the type of polyethylene described herein, the invention is not considered strictly limited to such materials. Rather, any present or future material which may be formed into a bag, and which exhibits the mechanical properties described below, is considered within the scope of the present invention.

In the furniture shipping industry, items of furniture are normally covered during shipment to protect the items from dust, soiling, and damage from scrapping against other articles. Typically the items of furniture are placed in large plastic sheeting or bags which may be closed to protect the article from the outside environment. Polyethylene is a common material from which to form these bags. It is desirable to have bags which may be opened and positioned over the furniture item as quickly and easily as possible. Normally the bags are provided to the end-users on rolls such that a bag is pulled off the roll and torn along a serrated edge connecting the removed bag to the next bag remaining on the roll. It is often difficult to separate the flaps forming the open end of the bag because of the plastic material's tendency to cling together or “block”, thereby slowing down the packaging process.

A further problem often arises with positioning the bag over the article of furniture. Because low-density polyethylene has a comparatively high coefficient of friction (COF), the bags are often difficult to slide over the furniture surfaces. While additives may be combined with the polyethylene in order to reduce the COF of the bag material, this creates a new problem. While the reduced COF of the bag material allows the bag to slip onto the furniture more easily, the reduced COF material has less ability to be gripped by adhesives. Thus, tape used on the outside surface of the bag to close the bag ends will not adhere, allowing the bag ends to work open. Perhaps more disrupting is that adhesive labels identifying the furniture item and its destination will not reliably adhere to the outer bag surface, requiring workmen to stop work while this information is obtained from another source. There is a significant need in the furniture shipping industry for a bag which will overcome these disadvantages.

### II. SUMMARY OF THE INVENTION

The present invention includes a bag formed of a dual surface material. The dual surface material has an inside surface with a first coefficient of friction and an outside surface with a second and higher coefficient of friction.

The present invention further includes an article of furniture covered with a plastic film bag. The plastic film bag has an inside surface with a first coefficient of friction and an outside surface with a second and higher coefficient of friction.

The present invention additionally includes a method of dividing a single web of plastic film into multiple webs for processing by multiple bag machines. The method includes the step of providing a conveyer system for running a first web of plastic film in a bag processing line; the step of slitting the first web of the plastic film into a second and third web; and the step of conveying the second and third webs to separate bag machines to produce two sets of plastic film bags.

### III. BRIEF DESCRIPTION OF THE DRAWINGS

FIG. 1 is side view of the process equipment used to manufacture the present invention.

FIG. 2 is a side sectional view of the extrusion die used in the process of forming the present invention.

FIG. 3 is another sectional view of the extrusion die of FIG. 2.

FIG. 4a is a schematic of the film bag processing system of the present invention.

FIG. 4b is a cross-section of the first web section.

FIG. 4c is a cross-section of the second and third web sections.

FIG. 5a is a top view of second and third web sections leaving the slitter and entering the bag machines.

FIG. 5b is a top view of a second and third web sections leaving the bag machines and entering the winders.

FIG. 6 is a side view of one type of bag produced according to the present invention.

FIG. 7 is an illustration of a conventional slitter blade assembly used in the method of the present invention.

### IV. DETAILED DESCRIPTION OF THE INVENTION

A preferred embodiment of the present invention includes a bag formed of a polymer film. The polymer film will further be formed of three separate polymers which are extruded simultaneously in a molten state and then combined together while still in a semi-molten state to form the bonded three-layered polymer film of the present invention. When the polymer film is formed into a bag, the three polymer layers may be defined as the “inside” polymer layer (forming the inside surface of the bag), the “middle” polymer layer and the “outside” polymer layer (forming the outside surface of the bag). It will be understood that each of these layers may itself be a combination of different polymer resins. As described in more detail below, the materials making up the individual layers are generally combined in a molten state.

The inside polymer layer may be formed from the combination of two polyethylene (PE) materials. One of these materials will be a high density PE with a density of approximately 0.949 gm/cc and a melt index of approximately 0.09 g/10 min. One example of such a high density PE is that designated as 6097 and is available from Union Carbide Corporation located at 39 Old Ridge Rd, Danbury, Conn. 06817. The second PE material is a linear low density PE having a density of approximately 0.918 and a melt index of approximately 0.9. One example of this linear low density PE is designated NTX-104 and is available from Mobil Oil Corporation. A preferred embodiment of the inside polymer layer will be 70% (all percentages being specified by weight) of 6097 combined with 30% of NTX-104. Those skilled in the art will understand that the percentage of compounds forming the inside polymer layer (and other layers described herein) may vary somewhat (e.g. +10%). The important parameter for the inside polymer layer is that it be predominantly a high-density polymer (e.g. greater than 60% high density PE) to give the inside layer a lower coefficient of friction.

The middle polymer layer may also be formed from two low-density PE materials. The first low density PE will have a density of approximately 0.918 and a melt index of approximately 0.25. One example of this low density PE is designated LTA-051 and is also available from Mobil Oil Corporation. A preferred embodiment of the middle polymer layer will be 60% LTA-051 combined with 40% NTX-104.

The outside polymer layer may be formed from the combination of several materials. The first is a linear low density PE having a density of approximately 0.924 and a melt index of approximately 0.8. One example of this low density PE is designated 7094 and is also available from Union Carbide Corporation. Another component of the outer layer is a low-density ethyl vinyl acetate (EVA) PE which will have a density of approximately 0.928 and a melt index of approximately 1.2. One example of this EVA PE is designated 1753 by Huntsman Corporation located at 3040 Post Oak Blvd., Houston, Tex. 77056. The outside layer PE material will further include an anti-blocking agent which will act to reduce the blocking tendencies of the finished film product when it is being wound onto rolls. Such an anti-blocking agent is available under the designation 1901 AB from Southwest Chemical located in Sea Brook, Tex. 77586. Furthermore, a process aid may be included in combined resins forming the outside layer. This material is a Viton process aid and is available from Ampacet Corporation located in Terrytown, N.Y. 10591. Neither the anti-blocking agent nor the process aid contribute to the properties of the final polymer film, rather these agents simply aid in the manufacturing process. One preferred embodiment of the outside polymer layer may be formed from the combination of 79.5% 7094, 17.5% 1753, 1% 1901 A/B and 2% process aid. The outside polymer layer is thus predominantly composed of a low density PE which will tend to give it a higher coefficient of friction.

The thickness or gauge of the three-layer film will typically range between approximately 3 and 10 mils, depending on the bags intended use and customer requirements. The average gauge variation will be ±2%, while the spot gauge variation may be ±10%. Regardless of the film gauge, the inside polymer layer will be approximately 25% of the three layer gauge, the middle layer approximately 50%, and the outside layer approximately 25%.

It has been found that the above three polymer layers each have certain mechanical properties which give the present invention significant advantages over the prior art. When the three layer film is produced as disclosed above, the inside polymer layer will typically have a coefficient of friction (COF) under the ASTM #D-1894 standard within the range of approximately 0.175 to 0.250 grams, with a more preferred COF being approximately 0.20 grams. The middle polymer layer may have a Dart Impact value under the ASTM #D-1709 standard in the approximate range of 70 to 200 grams per mil, with a more preferred value of 95 grams per mil. The outer polymer layer may have a COF under the ASTM #D-1894 standard in the range of approximately 0.300 to 0.600, with a more preferred COF of 0.55.

However, the present invention should not be considered strictly limited to the ranges given above. For example, while not as preferred, the inside layer could have a COF range of approximately 0.125 to 0.275 or possibly an even wider range. Similarly, the middle polymer layer might have a Dart Impact value in the approximate range of 70 to 200 grams per mils (or wider) and the outer polymer layer might have a COF range of approximately 0.300 to 0.600 (or wider).

When the three layer polymer film forms a bag, the bag has several characteristics which renders the bag far more useful as a shipping cover than the prior art bags used in this capacity. This is particularly true of bags used to protect furniture during shipment. The lower COF of the inside layer forms a “high slip” surface which will readily slide over furniture surfaces. The higher COF of the outside layer forms a “low slip” surface which will be better suited for the handling of the bag. For example, the outside layer is less likely to slip from the hands of workers. The outside layer may also be better gripped with adhesives, such as tape or labels. This is important since the open end of a bag is often closed by taping together the outside surfaces of the open end. Similarly, if labels fail to adhere to the bags, much confusion and delay may result from workers not having the information provided by the labels.

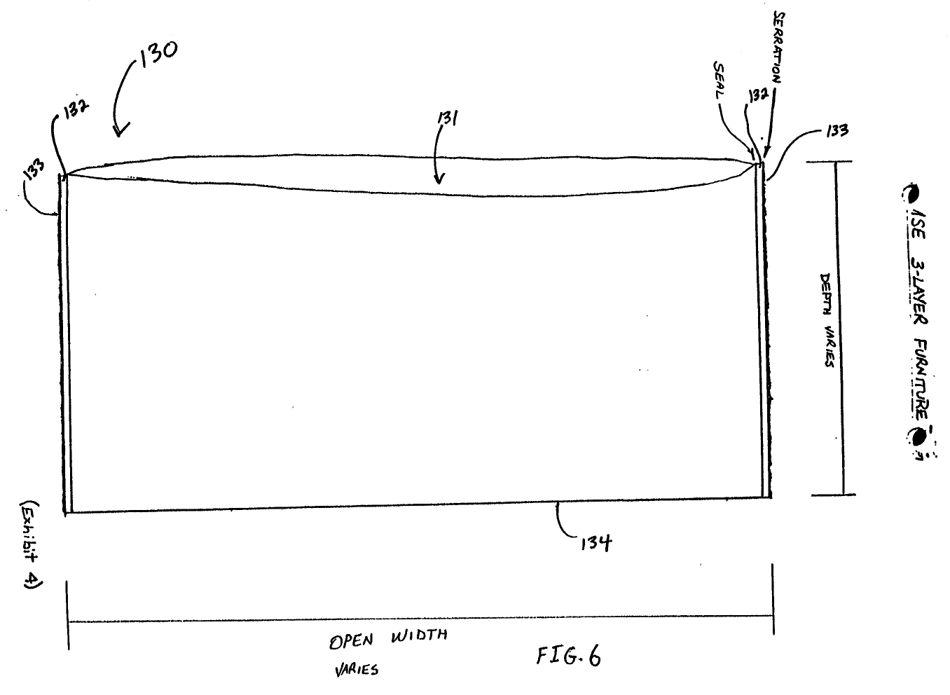

Another novel property of a bag produced from the polymer film of the present invention is the tendency of the open portion or mouth of such bags to separate. FIG. 6 illustrates a bag 130 with mouth or opening 131. As described above, the outside layer is composed of low-density polyethylene resins. Lower density PE resins have a much greater tendency to shrink in the heating and curing process than do higher density PE resins. Thus, the outside film layer will have a tendency to shrink relative to the inside film layer. This will cause the outside film layer to have a tendency to curl back on itself. Therefore, when formed into a bag, the film of the present invention will tend to separate in places where the opposing sheets of film are not joined together, i.e. the mouth of the bag. An additional property of high density PE (which forms the inside layer) is that it has little tendency to block. Hence, there is little blocking force between the inside layers of two opposing sheets of material and the tendency of the bag to open is not seriously inhibited by blocking forces. In essence, a bag formed of the polymer film of the present invention will tend to be “self opening” rather than requiring the user to struggle to separate the film at the mouth of the bag.

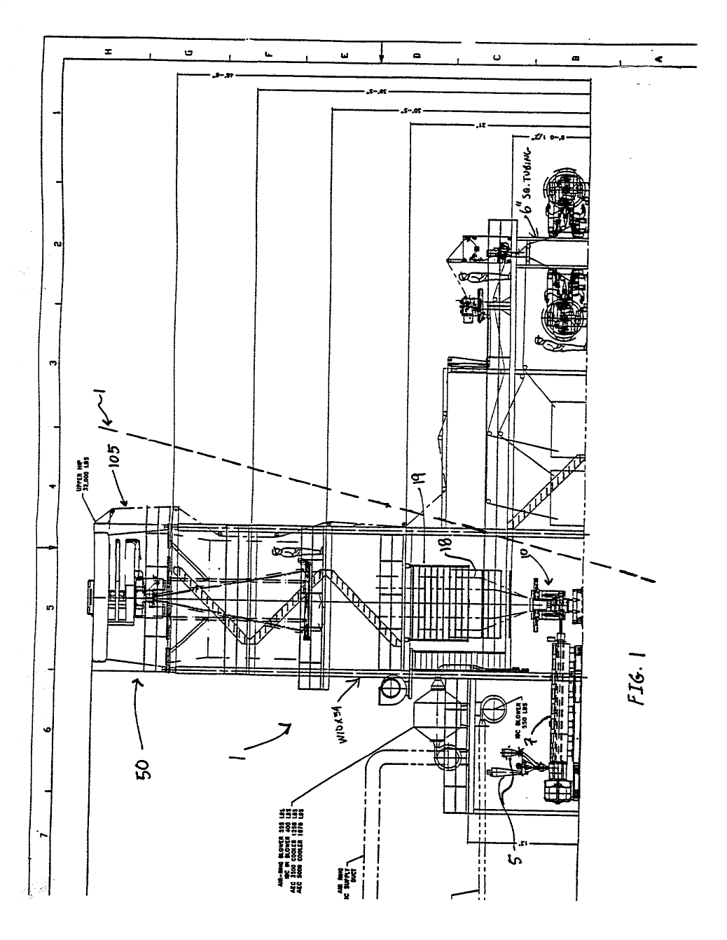

While the combination of the three above described polymers to form the polymer film of the present invention is believed to be novel, the actual machinery used for combining the separate polymers is well known in the art. Such machinery is disclosed in publications such as U.S. Pat. No. 4,303,710 to Bullard, which is incorporated by reference herein. A general schematic of this machinery is represented by the section of FIG. 1 to the left of dividing line 1. The section of FIG. 1 to the right of dividing line 1 represents the bag handling system of the present invention and will be explained in more detail below. However, the following relates to known machinery for combining the separate polymers into a single film. Typically, pelletized resinous materials of the type disclosed above are fed into a gravimetric blending devices 5 such as a continuous gravimetric manufactured by Process Controls of Atlanta, Ga. While only one blending device 5 is shown in FIG. 1, it will be understood that a blending device 5 for each of the three polymer layers mixes the resins in the appropriate percentages disclosed above. Each of the blenders 5 provides resin pellets to one of three single screw extruders 7 such as available from Egan Davis Standard located at 36 South Adamsville Road, Somerville, N.J., 08876. The extruders 7 will then melt the pelletized resin. Again, only one extruder 7 is shown, but it will be understood that three are generally employed.

The molten resin material forming the inside polymer layer will be fed through 7 which may be a 3.5 inch, 150 HP extruder. The resin material for the outside polymer layer will also be fed through a 3.5 inch, 150 HP extruder. The molten resin for the middle polymer layer will be fed through a 5 inch, 250-300 HP extruder. Each of these screw extruders 7 are employed with a L/D ratio of 30:1. The “L/D ration” is the length of the extruder screw relative to its diameter. As is known in the art, the pathways through which the molten resins travel will be separately temperature regulated to insure the molten resins are extruded at the proper temperature. In the embodiment disclosed herein, the heating profile of each extruders will be divided into multiple zones with each zone being measured and regulated by a computer system as is known in the art. Table 1 illustrates the separate heating zone for extruder A (resin of inside layer), B (resin of middle layer), and C (resin of outside layer) for one preferred embodiment of the present invention. Zone 1 is the area closest to the blenders 5 and the higher numbers represent zones further down the extruder.

TABLE 1

| | Temperatures (degrees F.) | | |
|---|---|---|---|
| Zone | Extruder A | Extruder B | Extruder C |
| Zone 1 | 390 | 260 | 340 |
| Zone 2 | 410 | 270 | 390 |
| Zone 3 | 400 | 275 | 380 |
| Zone 4 | 390 | 280 | 370 |
| Zone 5 | 385 | 300 | 360 |
| Zone 6 | — | 305 | — |
| Zone 7 | — | 310 | — |
| Melt | 380 | 380 | 380 |
| S/C | 400 | 400 | 400 |
| Adapt. | 400 | 400 | 400 |

Two other parameters controlling the extruders are the pressures at the output and the rotational speed of the screws. These parameters for the film of the present invention are set out in Table 2.

TABLE 2

| | Pressure | Screw Speed |
|---|---|---|
| Extruder A | 5905 PSI | 83.0 RPM |
| Extruder B | 4537 PSI | 60.0 RPM |
| Extruder C | 5156 PSI | 86.5 RPM |

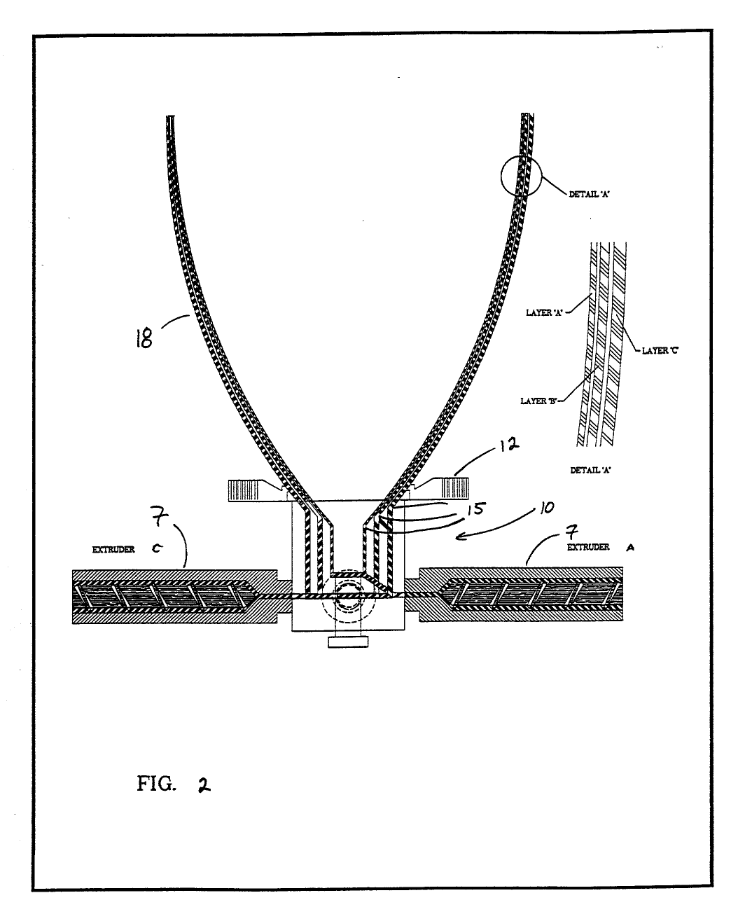

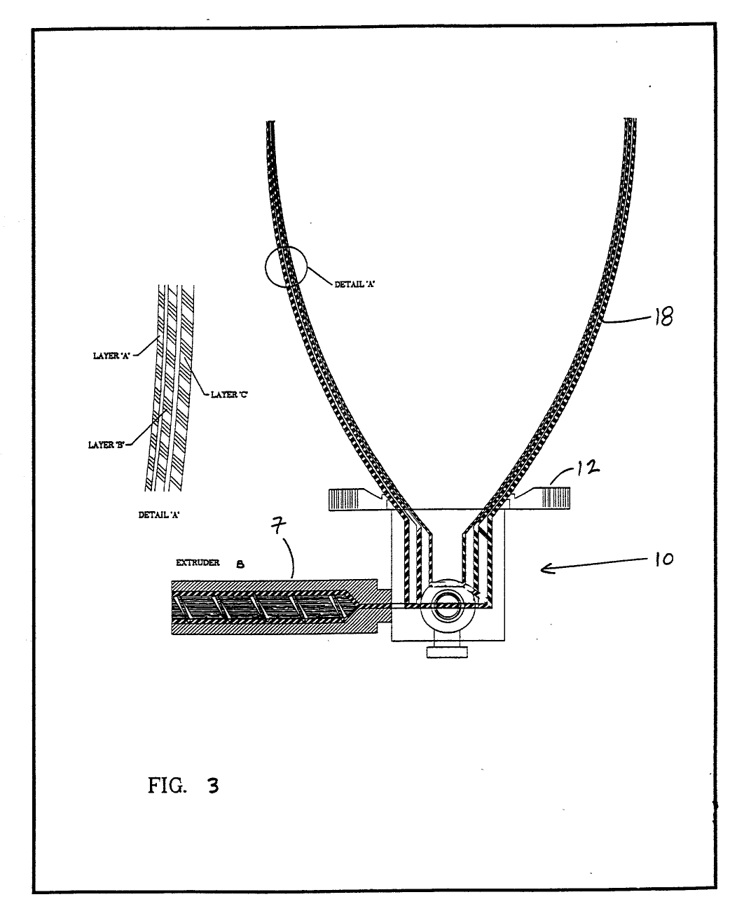

The molten resins are extruded to a 3-layer multi-layer extrusion die which forms part of a conventional entrapped air bubble extrusion technique known in the art as blown film extrusion. A preferred embodiment of the present invention utilizes an Egan Davis-Standard 28 inch 3-layer extrusion die. FIGS. 2 and 3 are simplified representations of a 3 layer die 10. FIG. 2 illustrates the first two extruders 7 and FIG. 3 illustrates the third extruder 7 which is hidden from view in FIG. 2. As best seen in FIG. 2, this die, in effect, extrudes the three molten resin materials through three separate channels which meet at an annular gap or lip 15, wherein the three concentric layers of resin will be extruded together and joined. The temperature at different sections of die 10 are also regulated. The manner of regulating the temperature at the different sections of die 10 is well known in the art. Table 3 illustrates the temperatures desired at various sections of die 10 when producing the film of the present invention.

TABLE 3

| Die Section | Temperatures (degrees F.) |
|---|---|
| Osc. Block | 380 |
| Osc. Base | 380 |
| Osc. Neck | 380 |
| Die Mandrel | 390 |
| Lower Die | 400 |
| Middle Die | 400 |
| Outer Lower Lip | 400 |
| Outer Top Lip | 400 |
| Inner Lower Lip | 350 |
| Inner Top Lip | 400 |

An air ring 12 provides a circle of high velocity, upward moving air which forms the now cooling resin into a continuous tube 18. As is known in the art, the three layers of polymer resin come into contact and bond together shortly before leaving the die lip 15. Referring back to FIG. 1, a conventional blown film tower 50 will extend above the die 10 and will provide a conduit for the tubular film 18 to travel upward while continuing to cool. In a preferred embodiment, the film tower 50 is sixty feet in height. The lower part of tower 50 includes a bubble cage 19 enclosing and containing tube 18. Bubble cage 19 is adjustable in diameter and the preferred diameter for a given size of tube 18 will normally be stated as a percentage of cage 19's fully open diameter. In one preferred process of the present invention, cage 19 will be opened approximately 62% of its full size. It is desired that tube 18 maintain a set distance from cage 19, but not actually come into contact with it. As the continuous tube 18 of polymer film travels from die 10, it will be expanded with air pressure to a diameter greater than that of the die lip 15. The degree to which the tube of polymer film is expanded as compared to the die diameter is known as the blow-up ratio or BLUR. Variations in the BUR affect the alignment of the molecular chains and therefore, affect the strength characteristics of the polymer film. It is believed that an acceptable range of the BUR as used in the present invention may be between approximately 2.1:1 and 4.5:1, with one preferred embodiment using a BUR of 2.73:1. Wider ranges of the BUR are intended to come within the scope of this invention should such wider ranges produce a polymer film have properties similar to those described herein. Typically, sensors will continuously measure the distance between tube 18 and bubble cage 19 and provide feedback information to computers controlling the process. If tube 18 is not within the specified distance of cage 19, air flow through air ring 12 will increase to expand tube 18. If tube 18 is closer than the specified distance to cage 19, air flow is decreased to contract tube 18.

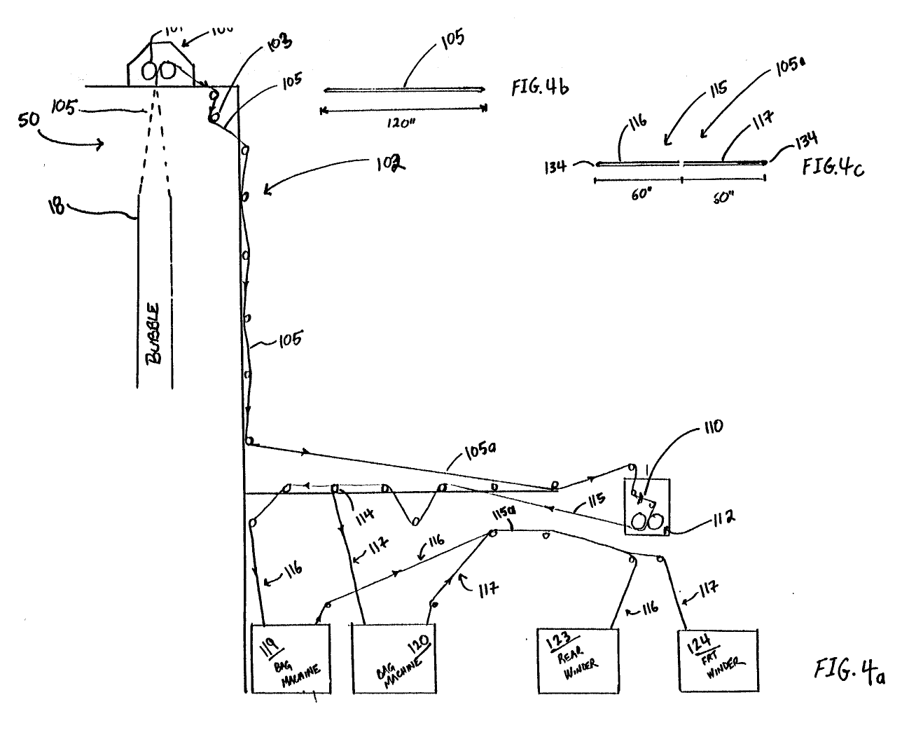

A second aspect of the present invention concerns a novel manner of handling the plastic film after the continuous length of film exits tower 50. This film handling system is generally seen in FIG. 1 to the right of dividing line 1. This continuous length of film extending from tube 18 is typically known as a “web” and will be designated as such henceforth. As best shown schematically in FIG. 4a, a nip station 100 will be position atop tower 50 to flatten tube 18 into the continuous web 105. Nip station 100 will include a set of nips 101 which are formed by a rubberized roller acting against a metal roller. Nips 101 will flatten tube 18 into a web cross-section represented in FIG. 4b. Nips 101 also provide the motor force for moving the web through the handling system. The speed at which the nips 101 (and other nips described herein) are run is typically monitored and controlled by an automated system. Those skilled in the art will recognize that controlling the relative speed between different sets of nips allows the tension placed on the web to be regulated as the web proceeds through the film handling system. Nips such as found in nip station 100 are conventional plastic film handling devices available from companies such as Egan Davis Standard identified above. Web 105 seen in FIG. 4b exaggerates the space between opposing sides of plastic material in order to illustrate the flattened tube-like nature of web 105. It will be understood that in actuality, that web 105 consists of the opposing sides of the plastic material being pressed closely together.

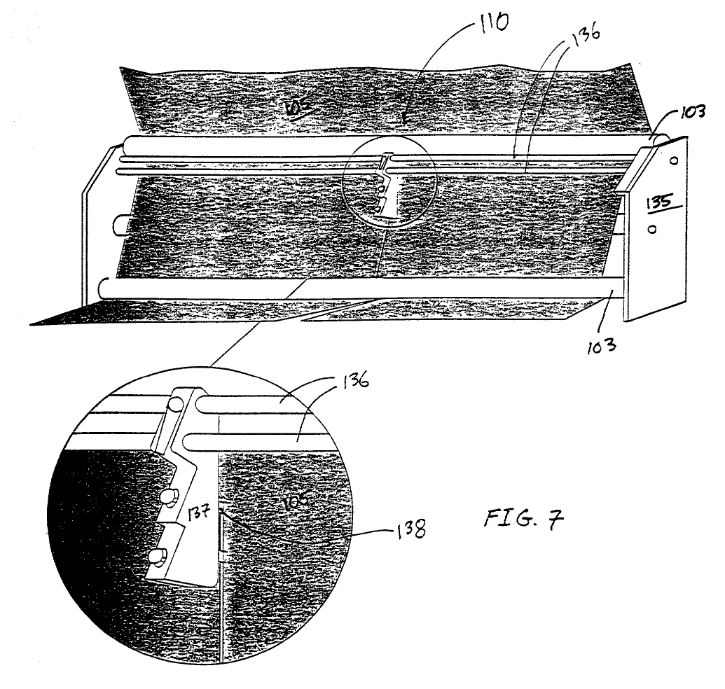

Web 105 will exit nip station 100 and be transported further into the film handling system by conveyer system 102. Conveyer system 102 will comprise a series of freely rotating rollers or idlers 103 upon which web 105 travels through the entire handling system. As mentioned, nips 101 provide the driving force for moving web 105 through conveyer system 102. Nips 112 (discussed below) also contribute to the driving force acting on the web 105. Web 105 travels down tower 50 and continues in a substantially horizontal direction toward slitter 110. This horizontal section of web 105 has been designated 105a for purposes which are explained below. Slitter 110 is a knife-like structure which is placed in the path of web 105a. FIG. 7 illustrates a conventional slitter assembly. A frame 135 supports a series of rollers 103 through which web 105 passes. Frame 135 also supports a pair of adjustment bars 136. Slidingly positioned on adjustment bars 136 is blade holder 137. It can be seen how a blade 138 is positioned in blade holder 137 and engages web 105. It will be understood that positioning blade holder 137 along the length of adjustment bars 136 determines where the web 105 will be divided. Slitter 110 will cleanly slice web 105a into two sections as suggested by FIG. 4c and labeled as divided web 115. Typically, web 105 a will be slit down its centerline. For purposes of illustration, web 105 is shown as being 120 inches wide in FIG. 4b and divided web 115 is shown comprising two 60 inch sections 116 and 117. In effect, web 105 is a first web section and sections 116 and 117 form second and third web sections respectively. However, it will be understood that web 105 and webs 116 and 117 form continuous lengths of film throughout the handling system.

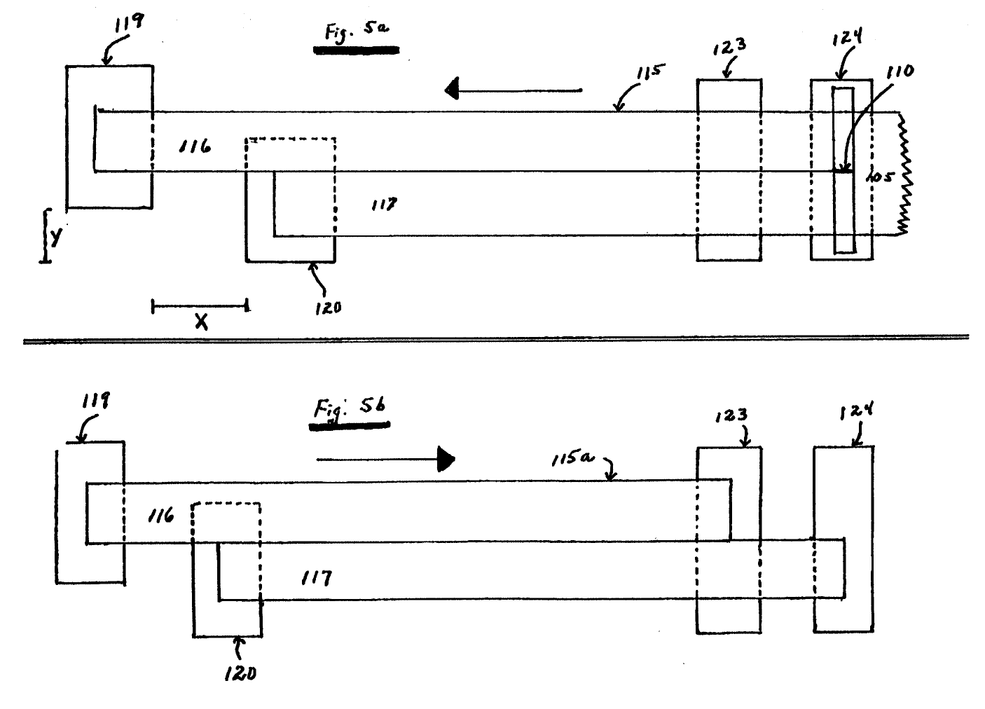

After web 115 has been divided by slitter 110, it proceeds through a second set of nips 112 which provides additional motor force to web 115 to insure the entire length of the web remains under proper tension and travels at the desired speed. The path of web 115 after exiting nips 112 is shown from a schematic top view in FIG. 5a. FIG. 5a is a view of the handling system with web 105a (see FIG. 4a) removed to allow viewing of divided web 115. It can be seen that webs 116 and 117 are conveyed side by side until reaching their respective bag machines 119 and 120. At this point, webs 116 and 117 take separate paths into the bag machines. It can be seen that that bag machines 119 and 120 should be offset from one another both in the “x” direction and in the “y” direction as seen in FIG. 5a. This manner of offsetting allows webs 116 and 117 to proceed side by side except in the vicinity of bag machines 119 and 120 or bag winders 123 and 124 (explained below). Upon entering the bag machines, both webs 116 and 117 will be formed into bags by forming end seals and seriating the film adjacent to the seals for ease of tearing by the end user. FIG. 6 illustrates a typical bag formed by bag machines 119 and 120. The bottom of the bag will be formed by fold 134 (see also FIG. 4c) and heat seals 132 will be formed at each end of the bag. Serrations will be formed adjacent to the heat seals, but the serrations will not completely separate one bag from the adjoining bags formed in the continuous web of plastic film. The bag opening 131 is simply the open edge of the web which was cut by slitter 110 (see the mid-section of FIG. 4c). Naturally, the length of the bag is adjustable depending on how far apart seals 132 are spaced. Nor is the bag necessarily limited the configuration shown in FIG. 6, but could take on several different configurations well known in the art. Bag machines 119 and 120 could be any bag machines known in the art such as the 80 inch bag machines available from Egan Davis Standard as identified above.

Returning to FIG. 4a, it can be seen that after webs 116 and 117 exit bag machines 119 and 120, the webs (now comprising a series of bags) are once again run side by side as divided web 115a as the web approaches bag winders 123 and 124. FIG. 5b is a top view schematic with webs 105a and 115 (see FIG. 4a) removed in order to clearly show web 115a. It can be seen in FIGS. 4a and 5b how webs 116 and 117 once again separate as they proceed into bag winders 123 and 124. As seen in FIG. 5b bag winders 123 and 124 will be aligned, but second and third webs 116 and 117 will enter their respective winders on opposite sides of the winders. It will be understood that winders 123 and 124 are conventional machines which form the continuous web of bags into a roll. The roll is typically the end product received by the ultimate user of the bags. Bag winders such as 123 and 124 are available from J&C Industries.

Those skilled in the art will recognize that the above novel web handling process is far more efficient than prior art methods. The prior art simply ran one web through the conveyer system. If 120 inch bags were required, a 120 inch web would be run. If 60 inch bags were required, a single 60 inch web would be run. However, the web handling process of the present invention actually converts a 120 inch web into two 60 inch webs, thereby doubling the bag output over the prior art for the same amount of operation time.

Although certain preferred embodiments have been described above, it will be appreciated by those skilled in the art to which the present invention pertains that modifications, changes, and improvements may be made without departing from the spirit of the invention defined by the claims. All such modifications, changes, and improvements are intended to come within the scope of the present invention.

We claim:

1. A bag formed of a dual surface material wherein said dual surface material comprises:
a. an inside surface having a first coefficient of friction;
b. an outside surface having a second coefficient of friction higher than said first coefficient of friction.

2. The dual surface bag of claim 1, wherein said dual surface material is a plastic.

3. The dual surface bag of claim 1, wherein said dual surface material is a polymer.

4. The dual surface bag of claim 2, wherein said plastic material is a polyethylene material.

5. The dual surface bag of claim 1, wherein inside surface has a COF range of approximately 0.125 to 0.275 and said outside surface has a COF range of approximately 0.300 to 0.600.

6. The dual surface bag of claim 5, wherein said inside surface has a COF range of approximately 0.175 to 0.250 and said outside surface has a COF range of approximately 0.350 to 0.600.

7. The dual surface bag of claim 2, wherein said plastic comprises three layers.

8. The dual surface bag of claim 6, wherein said three layers further comprise:
a. a first layer having a COF range of approximately 0.175 to 0.250; and
b. a second layer having a Dart Impact of approximately 95 grams per mil; and
c. a third layer having a COF range of approximately 0.350 to 0.600.

9. The dual surface bag of claim 1, wherein said inside surface comprises a first plastic material having a density and said outside surface comprises a second plastic material having a lower density than said first plastic material, thereby biasing opposing inside surfaces of said bag away from one another.

10. The dual surface bag of claim 8, wherein said second plastic material exerts a curling force on said first plastic material.

11. An article of furniture covered with a plastic film bag comprising:
a. an article of furniture;
b. a plastic film bag covering said article wherein said plastic film comprises:
i. an inside surface having a first coefficient of friction;
ii. an outside surface having a second coefficient of friction higher than said first coefficient of friction.

12. A method of dividing a single web of plastic film into multiple webs for processing by multiple bag machines, said method comprising the steps of:
a. providing a conveyer system for running a first web of plastic film in a bag processing line;
b. slitting said first web of said plastic film into a second and third web;
c. conveying said second and third web to separate bag machines to produce two sets of plastic film bags.

13. The method of claim 11, wherein said first web has a centerline and said step of slitting is performed approximately along said centerline.

14. The method of claim 11, wherein said separate bag machines are offset from one another.

15. The method of claim 13, wherein said second and third webs are each conveyed to a separate winder, producing two separate rolls of plastic film bags.

16. A blown film extrusion process comprising the steps of:
a. feeding a first source of resin to a blown film extrusion die such that said first source of resin forms an inner layer of film; and
b. feeding a second source of resin having a lower density than said first source to said die such that said second source of resin forms an outer film layer.

17. The process according to claim 15, further comprising the step of feeding to said die a third source of resin having a higher strength than one of said first or second sources such that said third source of resin forms a middle film layer.
